(19) United States
(12) Patent Application Publication
(10) Pub. No.: US 2017/0272802 A1
(43) Pub. Date: Sep. 21, 2017

(54) ELECTRONIC DEVICE AND METHOD OF OPERATING THE SAME

(71) Applicant: SAMSUNG ELECTRONICS CO., LTD., Suwon-si (KR)

(72) Inventors: Soo-hong KIM, Seoul (KR); In-beom KIM, Suwon-si (KR); Seok-hun KANG, Suwon-si (KR); Bo-ram KIM, Suwon-si (KR); Kyung-mi HA, Yongin-si (KR)

(21) Appl. No.: 15/399,960

(22) Filed: Jan. 6, 2017

(30) Foreign Application Priority Data
Mar. 17, 2016 (KR) 10-2016-0032066

(51) Int. Cl. H04N 21/422; H04N 21/41

(52) U.S. Cl. CPC H04N 21/42221; H04N 21/4131

(57) ABSTRACT

An electronic device and a method of operating the same are provided. The electronic device includes a controller configured to receive a baseband signal corresponding to an infrared ray (IR) signal for controlling a peripheral device, to determine a first carrier frequency corresponding to the baseband signal based on remote controller code information included in the baseband signal, and to combine the first carrier frequency with the baseband signal; and a transmitter configured to transmit the baseband signal combined with the first carrier frequency to the peripheral device.

### CROSS-REFERENCE TO RELATED APPLICATION

This application is based on and claims priority under 35 U.S.C. §119 to Korean Patent Application No. 10-2016-0032066, filed on Mar. 17, 2016, in the Korean Intellectual Property Office, the disclosure of which is incorporated by reference herein in its entirety.

### BACKGROUND

1. Field

The present disclosure relates generally to an electronic device and a method of operating the same, and for example, to an electronic device that transfers a signal of a remote controller and a method of operating the same.

2. Description of Related Art

In order to control a peripheral device using a remote controller, an infrared ray (IR) repeater may be used when the peripheral device is unable to directly receive an IR signal from the remote controller.

However, since a conventional infrared repeater supports only one carrier frequency, it is still inconvenient to operate a remote controller using a carrier frequency not supported by an IR repeater.

### SUMMARY

An electronic device that receives infrared ray (IR) signals from a plurality of remote controllers and transmits a signal for controlling peripheral devices corresponding to the IR signals to the respective peripheral devices corresponding to the respective remote controller and a method of operating the electronic device are provided.

Additional aspects will be set forth in part in the description which follows and, in part, will be apparent from the description.

According to an example aspect of an example embodiment, an electronic device includes a controller configured to receive a baseband signal corresponding to an infrared ray (IR) signal for controlling a peripheral device, to determine a first carrier frequency corresponding to the baseband signal based on remote controller code information included in the baseband signal, and to combine the first carrier frequency with the baseband signal; and a transmitter configured to transmit the baseband signal combined with the first carrier frequency to the peripheral device.

According to an example aspect of another example embodiment, a method of controlling an electronic device is provided, the method includes receiving a baseband signal corresponding to an infrared ray (IR) signal for controlling a peripheral device; determining a first carrier frequency corresponding to the baseband signal based on remote controller code information included in the baseband signal; combining the first carrier frequency with the baseband signal; and transmitting the baseband signal combined with the first carrier frequency to the peripheral device.

According to an example aspect of another example embodiment, a computer readable recording medium is provided having recorded thereon a computer program for implementing a method including receiving a baseband signal corresponding to an infrared ray (IR) signal for controlling a peripheral device; determining a first carrier frequency corresponding to the baseband signal based on remote controller code information included in the baseband signal; combining the first carrier frequency with the baseband signal; and transmitting the baseband signal combined with the first carrier frequency to the peripheral device.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIGS. 1A and 1B are diagrams illustrating an example in which a control signal is transmitted to an external electronic device or an electronic device using a remote controller device, according to an example embodiment;

FIG. 2 is a block diagram illustrating an example configuration of an electronic device according to an example embodiment;

FIG. 3 is a block diagram illustrating an example configuration of an electronic device according to an example embodiment;

FIG. 4 is a diagram illustrating an example of controlling a plurality of peripheral devices via an external electronic device and an electronic device, according to an example embodiment;

FIG. 5 is a diagram illustrating an example of controlling a peripheral device via electronic devices, according to an example embodiment;

FIGS. 6A and 6B are diagrams illustrating examples of a screen image displayed on a display of an electronic device when a peripheral device is being controlled using a remote controller device, according to an example embodiment;

FIG. 7 is a flowchart illustrating an example method of operating an electronic device, according to an example embodiment; and

FIG. 8 is a flowchart illustrating an example method of operating an electronic device, according to an example embodiment.

### DETAILED DESCRIPTION

Reference will now be made in greater detail to various example embodiments, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the figures, to explain aspects. Expressions such as “at least one of,” when preceding a list of elements, modify the entire list of elements and do not modify the individual elements of the list.

Hereinafter, various example embodiments of the present disclosure will be described in detail with reference to the accompanying drawings. However, the present disclosure may be embodied in many different forms and is not limited to the embodiments described herein. In order to clearly illustrate the present disclosure in the drawings, parts not related to the description may be omitted, and like elements are denoted by like reference numerals throughout the description.

Terms used in the description may be used to describe various elements, but the elements should not be limited by the terms. Terms are used only for the purpose of distinguishing one element from another.

Throughout the description, when a part is referred to as being “connected” to another part, it includes not only the case where it is “directly connected” but also the case where it is “electrically connected.” Also, when a part is “connected” to another part, it includes a case where a part is in a state where data communication can be performed through signal transmission/reception with another part.

Also, when an element is referred to as “including” an element, it is to be understood that the element may include other elements as well, without departing from the spirit or scope of the present disclosure. Also, the terms “part”, “module”, and the like described in the description refer to a unit for processing at least one function or operation, which may be implemented as hardware, software, or a combination of hardware and software.

The accompanying drawings can be schematically illustrated to describe an example embodiment of the present disclosure, and some dimensions may be exaggerated for clarity. Similarly, substantial portions of the drawings may be arbitrarily represented.

With respect to the terms in the various example embodiments of the present disclosure, the general terms which are currently and widely used are selected in consideration of functions of structural elements in the various embodiments of the present disclosure. However, meanings of the terms may be changed according to intention, a judicial precedent, appearance of a new technology, and the like. In addition, in certain cases, a term which is not commonly used may be selected. In such a case, the meaning of the term will be described in detail at the corresponding part in the description of the present disclosure. Therefore, the terms used in the various example embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the description may refer, for example, to units for processing at least one function and operation and can be implemented by hardware components or software components and combinations thereof.

Embodiments and accompanying drawings described in the present disclosure are intended to illustrate the present disclosure through various example embodiments of the present disclosure and embodiments described in the present disclosure and the accompanying drawings are not intended to limit the present disclosure.

The term “user” used in embodiments of the present disclosure refers to a person who controls a function or an operation of an electronic device or external electronic device by using a remote controller and may include, but is not limited to, a viewer, an administrator, and an installation technician.

In various example embodiments of the present disclosure, the term “peripheral device” may refer, for example, to an electronic device that a user ultimately wants to control by using a remote controller.

The term “control signal” in various example embodiments of the present disclosure may include, but is not limited to, signals for controlling a peripheral device, such as a baseband signal.

It will be apparent to one of ordinary skill in the art that the term “external electronic device” used in various example embodiments of the present disclosure is only used to distinguish between an “electronic device” and an “external electronic device” and the features or characteristics of the “electronic device” may not be different from those of the “external electronic device.”

Hereinafter, the present disclosure will be described in greater detail with reference to the accompanying drawings.

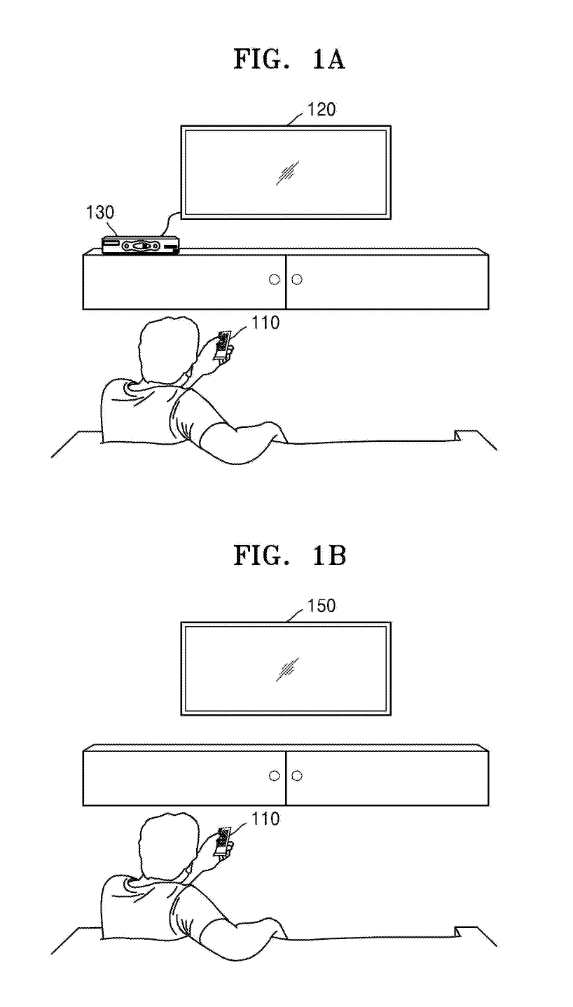

FIGS. 1A and 1B are diagrams illustrating an example in which a control signal is transmitted to an external electronic device 120 or an electronic device 150 using a remote controller device 110, according to an example embodiment.

As illustrated in FIG. 1A and 1B, electronic devices 130 and 150 may include IR repeaters. However, it is merely an example, and each of the electronic devices 130 and 150 may be one of various electronic devices including a television (TV), a mobile phone, a tablet personal computer (PC), a digital camera, a camcorder, a laptop computer, a desktop, an e-book terminal, a digital broadcast terminal, a personal digital assistant (PDA), a portable multimedia player (PMP), a navigation device, an MP3 player, a wearable device, an air conditioner, a microwave oven, an audio player, and a DVD player, or the like, but is not limited thereto. Similarly, the external electronic device 120 may be a TV. However, it is merely an example, and the external electronic device 120 may be one of various electronic devices as stated above with respect to the electronic devices 130 and 150. Furthermore, a peripheral device (not shown in FIGS. 1A and 1B) may be one of various electronic devices as stated above with respect to the external electronic device 120 and the electronic devices 130 and 150. The electronic devices 130 and 150, the external electronic device 120, and the peripheral device according to embodiments are not limited to the above-stated devices and may include new devices according to technological advancements.

According to an example embodiment, the remote controller device 110 illustrated in FIGS. 1A and 1B is merely an example, and the remote controller device 110 may be implemented as one of various types of devices for controlling a peripheral device. For example, the remote controller device 110 may be a remote controller or a smart phone or may be a mouse or a keyboard for transmitting an infrared ray (IR) signal. However, types of the remote controller device 110 are not limited thereto.

Furthermore, the remote controller device 110 may control a peripheral device using short-distance communication including an IR or Bluetooth. The remote controller device 110 may be configured to include, without limitation, at least one of a provided key (including a button), a touchpad, a microphone capable of receiving a user's voice, and a sensor capable of recognizing a motion of the remote controller device 110 for controlling functions of a peripheral device.

The remote controller device 110 may also include a power ON/OFF button for turning the electronic devices 130 and 150 or a peripheral device ON/OFF.

FIG. 1A is a diagram illustrating an example in which a control signal is transmitted to the external electronic device 120 using the remote controller device 110 according to an example embodiment.

Referring to FIG. 1A, a device for receiving an IR signal from the remote controller device 110 (e.g., the external electronic device 120) and a device for transmitting a signal for controlling a peripheral device to the peripheral device (e.g., the electronic device 130) may be implemented as separate devices.

A carrier frequency may refer, for example, to a frequency at which a communication signal is transmitted. According to an example embodiment, the carrier frequency may be in a range of tens of kHz, and more particularly, a range from 32 kHz to 57 kHz. However, the present disclosure is not limited thereto. Furthermore, carrier frequencies used for controlling peripheral devices may vary depending on types of the peripheral devices, manufacturers of the peripheral devices, etc. For example, a carrier frequency used for controlling an air conditioner may be 36 kHz, a carrier frequency used for controlling a microwave oven may be 40 kHz, and a carrier frequency used for controlling a TV may be 57 kHz. However, the present disclosure is not limited thereto.

According to an example embodiment, carrier frequencies used for transmitting signals for controlling respective peripheral devices may be defined in advance. Furthermore, a carrier frequency used for transmitting a signal for controlling a particular peripheral device may be changed based on a setting of a user, an update of a server, etc.

According to an example embodiment, the external electronic device 120 that received an IR signal may generate a baseband signal by separating a carrier frequency from the IR signal. The electronic device 130 may receive the baseband signal from the external electronic device 120. Furthermore, the electronic device 130 may analyze the baseband signal received from the external electronic device 120 and determine a carrier frequency. Once the carrier frequency is determined, the electronic device 130 may generate a particular frequency. The electronic device 130 may combine the generated particular frequency with the baseband signal and transmit the same to a peripheral device.

More particularly, the particular frequency may be a frequency within a pre-set error range around the carrier frequency. In other words, the particular frequency may be a frequency within a certain frequency range around the carrier frequency. For example, when the carrier frequency is 36 kHz and a bandwidth is 0.1 kHz, the particular frequency may be a frequency between 35.9 kHz and 36.1 kHz.

According to an embodiment, the electronic device 130 may include a plurality of electronic devices, and the external electronic device 120 that received an IR signal from the remote controller device 110 may transmit baseband signals to the plurality of electronic devices.

According to an embodiment, when the peripheral device is unable to directly receive an IR signal from the remote controller device 110 (e.g., when a peripheral device and the remote controller 110 are located in spaces isolated from each other), a user may direct the remote controller 110 toward to the external electronic device 120 and transmit an IR signal. The external electronic device 120 may transmit a baseband signal based on the IR signal to the electronic device 130 located in a same space as the peripheral device. The electronic device 130 may transmit a control signal to the peripheral device based on the received baseband signal. Accordingly, the user may control the peripheral device located in the space isolated from the remote controller device 110.

According to an embodiment, when the external electronic device 120 transmits a baseband signal to the electronic device 130, the external electronic device 120 and electronic device 130 may be connected to each other by wire or wirelessly.

Although FIG. 1A illustrates an embodiment in which an external electronic device and an electronic device are implemented as separate devices, the present disclosure is not limited thereto.

An electronic device according to an embodiment may be implemented to perform operations performed by both the electronic device 130 and the external electronic device 120.

FIG. 1B is a diagram illustrating an example in which a control signal is transmitted to the electronic device 150 using the remote controller device 110, according to an example embodiment. Descriptions identical to those given above with reference to FIG. 1A will be omitted below.

Referring to FIG. 1B, the electronic device 150 according to an embodiment may receive an IR signal from the remote controller device 110. The electronic device 150 may generate a baseband signal by separating a particular frequency from the received IR signal. More particularly, the particular frequency may be a frequency within a certain error range around a carrier frequency.

Furthermore, the electronic device 150 may determine a carrier frequency by analyzing the baseband signal. Once the carrier frequency is determined, the electronic device 150 may generate a particular frequency.

The electronic device 150 may combine the generated particular frequency with the baseband signal and transmit the same to a peripheral device. More particularly, the electronic device 150 may transmit an IR signal generated by combining the generated particular frequency with the baseband signal to the peripheral device.

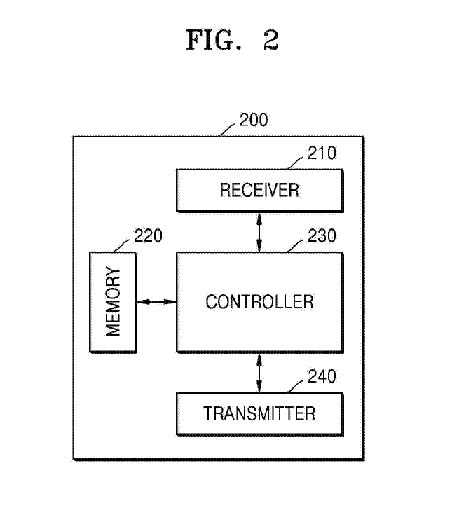

FIG. 2 is a block diagram illustrating an example configuration of an electronic device 200 according to an example embodiment.

The electronic device 200 of FIG. 2 may be an embodiment of the electronic device 130 of FIG. 1A or the electronic device 150 of FIG. 1B.

The electronic device 200 may include a receiver 210, a memory 220, a controller (e.g., including processing circuitry) 230, and a transmitter 240.

The receiver 210 may receive an IR signal from the remote controller device 110 corresponding to a peripheral device, according to an embodiment.

The receiver 210 may generate a baseband signal by separating a carrier frequency from the IR signal, according to an embodiment.

The memory 220 may store a database including information regarding a carrier frequency corresponding to remote control code information, according to an embodiment.

According to an embodiment, remote control code information may include, but is not limited to, a lead code, a custom code, and a data code. Furthermore, control signals transmitted by the respective remote control apparatuses 110 may have different lead codes, different custom codes, and different data codes.

For example, the database may include information indicating that a corresponding carrier frequency is 36 kHz when remote control code information includes a lead code a, a custom code b, and a data code c, or may include information indicating that a corresponding carrier frequency is 57 kHz when remote control code information includes a lead code d, a custom code e, and a data code f. However, the present disclosure is not limited thereto.

Furthermore, the database may receive information from a server at every pre-set interval and may be updated based on the received information. Alternatively, the database may be updated based on information input by a user.

The controller 230 may include various processing circuitry configured to determine a carrier frequency corresponding to a baseband signal based on remote control code information included in the baseband signal, according to an embodiment.

According to an embodiment, the controller 230 may determine a carrier frequency by comparing a database stored in the memory 220 with remote control code information included in a baseband signal. For example, when the database includes information indicating that a carrier frequency corresponding to a lead code a, a custom code b, and a data code c is 36 kHz and the remote control included in the received baseband signal includes the read code a, the custom code b, and the data code c, the controller 230 may determine that the carrier frequency is 36 kHz.

According to an embodiment, the controller 230 may generate a particular frequency within a pre-set error range around a carrier frequency. More particularly, the particular frequency may be a frequency within a pre-set error range around the carrier frequency. In other words, the particular frequency may be a frequency within a certain frequency range around the carrier frequency.

For example, when it is determined that the carrier frequency is 36 kHz, the controller 230 may generate a particular frequency, within the range from 35.9 kHz to 36.1 kHz, of around 36 kHz.

The controller 230 may combine the particular frequency generated according to an embodiment with the baseband signal.

The transmitter 240 may transmit the baseband signal combined with the particular frequency generated according to an embodiment to a peripheral device. At this time, a signal generated by combining the particular frequency with the baseband signal may be an IR signal. However, the present disclosure is not limited thereto.

According to an embodiment, an electronic device including the receiver 210 (which may correspond to the external electronic device 120 of FIG. 1A) and an electronic device including the memory 220, the controller 230, and the transmitter 240 (which may correspond to the electronic device 130 of FIG. 1A) may interact with each other, where communicators (not shown in FIG. 2) of both of the electronic devices may be used for the interaction.

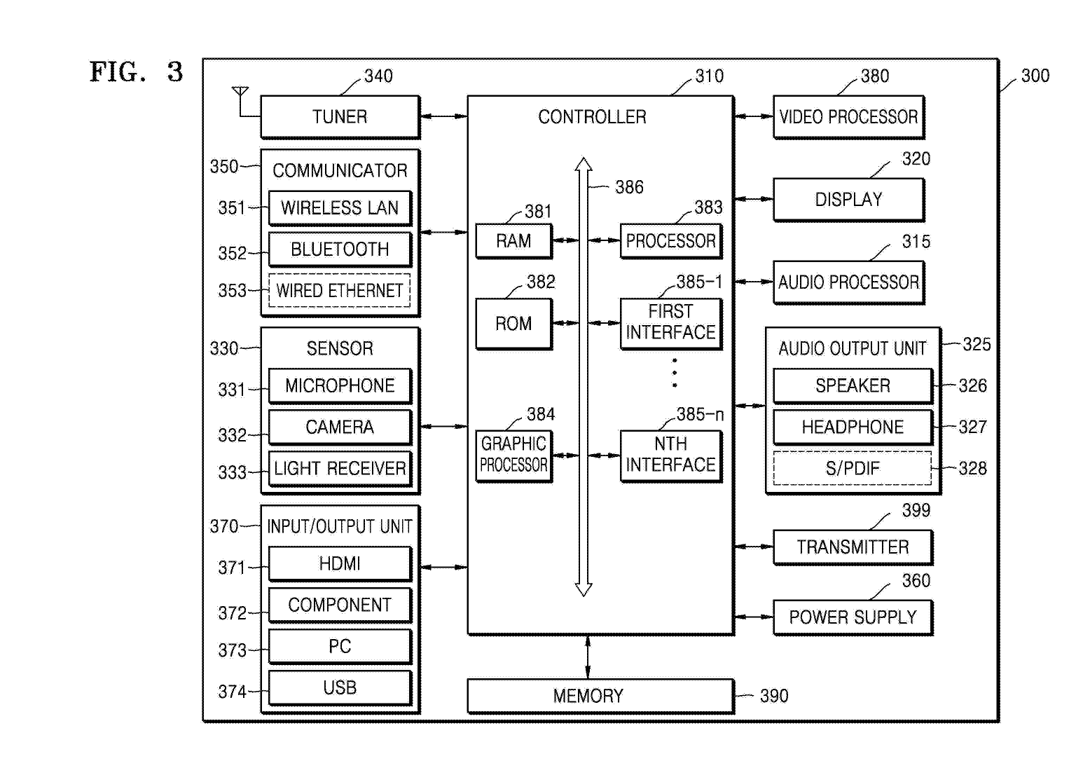

FIG. 3 is a block diagram illustrating an example configuration of an electronic device 300 according to an embodiment. The electronic device 300 according to an embodiment may be an image display apparatus. For example, the electronic device 300 may be implemented as an analog TV, a digital TV, a 3D TV, a smart TV, a light-emitting diode (LED) TV, an organic light-emitting diode (OLED) TV, a plasma TV, or a monitor, but is not limited thereto.

Referring to FIG. 3, the electronic device 300 may include a controller (e.g., including processing circuitry) 310, a sensor 330, a communicator (e.g., including communication circuitry) 350, a memory 390, a transmitter 399, a video processor 380, an audio processor 315, an audio output unit (e.g., including audio output circuitry) 325, a power supply 360, a tuner 340, and an input/output unit (e.g., including input/output circuitry) 370. The sensor 330 of FIG. 3, and more particularly, a light receiver 333, the memory 390, the controller 310, and the transmitter 399 may correspond to the receiver 210, the memory 220, the controller 230, and the transmitter 240 of FIG. 2, respectively.

Regarding the controller 310, the sensor 330, the communicator 350, the memory 390, and the transmitter 399, descriptions identical to those given above with reference to FIGS. 2A and 2B will be omitted below.

The video processor 380 may include various circuitry configured to process video data received by the electronic device 300, according to an embodiment.

The display 320 may display video included in a broadcast signal received via the tuner 340 on a display screen under the control of the controller 310. The display 320 may display content (e.g., a moving picture) input via the communicator 350 or the input/output unit 370. The display 320 may output an image stored in the memory 390 under the control of the controller 310. The audio processor 115 may process audio data.

The audio output unit 325 may include various audio output circuitry configured to output audio included in a broadcast signal received via the tuner 340 under the control of the controller 310. The audio output unit 325 may output audio (e.g., voice, sound) input via the communicator 350 or the input/output unit 370. The audio output unit 325 may output audio stored in the memory 390 under the control of the controller 310. The audio output unit 325 may include various circuitry audio output circuitry, such as, for example, and without limitation, speaker 326, headphone 327 and S/PDIF 328.

The power supply 360 may supply power input from an external power source to internal components of the electronic device 300 under the control of the controller 310. Furthermore, the power supply 360 may supply power to the internal components from one or more batteries (not shown) arranged inside the electronic device 300 under the control of the controller 310.

The tuner 340 may tune and select only a frequency of a channel to be received by a display device from among many radio wave components through amplification, mixing, and resonance of a broadcast signal received by wire or wirelessly.

The communicator 350 may include various communication circuitry configured to connect the electronic device 300 to an external device (e.g., an audio device or the like) under the control of the controller 310. The controller may transmit/receive content to/from the external device connected via the communicator 350, download an application from the external device, or browse the web.

The communicator 350 may receive a baseband signal corresponding to an IR signal for controlling a peripheral device, according to an embodiment. More particularly, under control of the controller 310, the communicator 350 may receive a baseband signal originating from the remote controller device 110.

According to an embodiment, the communicator 350 may include various communication circuitry, such as, for example, and without limitation, one of wireless local area network (LAN) 351, Bluetooth 352, and wired Ethernet 353. The communicator 350 may also include a combination of wireless LAN 351, Bluetooth 352, and wired Ethernet 353. A control signal may be implemented as a Bluetooth signal, a radio frequency (RF) signal, or a Wi-Fi signal.

The sensor 330 may sense a user's voice, a user's image, or a user's interaction. The sensor 330 may include a microphone, a camera, and a light receiver.

A microphone 331 may receive a user's uttered voice, and a camera 332 may capture a user's image.

The light receiver 333 receives an optical signal received from the external remote controller device 110 through an optical window (not shown) of a bezel of the display 320 or the like. The light receiver 333 may receive an optical signal corresponding to a user input (e.g., a touch, a press, a touch gesture, a voice, or a motion) from the remote controller device 110, where the optical signal according to an embodiment may include an IR signal. A control signal may be extracted from the received optical signal under the control of the controller 310. According to an embodiment, the control signal may include a baseband signal.

The input/output unit 370 may include various input/output circuitry and receive video (e.g., a moving picture), audio (e.g., voice, music, etc.), and additional information (e.g., an electronic program guide (EPG), etc.) from the outside of the electronic device 300 under the control of the controller 310, according to an embodiment. The input/output unit 370 may include various input/output circuitry, such as, for example, and without limitation, HDMI 371, component 372, PC 373 and USB 374.

The controller 310 controls the overall operation of the electronic device 300 and signal flows between the internal components of the electronic device 300, and performs a data processing function. The controller 310 may execute an operation system (OS) and various applications stored in the memory 390 when a user applies an input or pre-set conditions are satisfied.

The controller 310 may include various circuitry, including, for example, a random-access memory (RAM) 381 that stores signals or data input from outside the electronic device 300 or is used as a storage area corresponding to various tasks performed in the electronic device 300, a read-only memory (ROM) 382 that stores a control program for controlling the electronic device 300, and a processor 383.

The processor 383 may include a graphics processor (not shown) for graphics processing corresponding to video. The processor 383 may also include a plurality of processors.

According to an embodiment, a graphics processor 384 may generate a screen image including various objects such as an icon, an image, text, and the like using a calculator (not shown) and a renderer (not shown).

According to an embodiment, the first through n^{th} interfaces 385-1 through 385-n are connected to various components described above. One of the first through nth interfaces 385-1 through 385-n may be a network interface connected to an external device via the network.

According to an embodiment, the RAM 381, the ROM 382, the processor 383, the graphics processor 384, and the first through nth interfaces 385-1 through 385-n may be connected to one another via an internal bus 386.

The memory 390 may store various data, programs, or applications for driving and controlling the electronic device 300 under the control of the controller 310. The memory 390 may store input/output signals or data corresponding to operations of the video processor 380, the display 320, the audio processor 315, the audio output unit 325, the power supply 360, the tuner 340, the communicator 350, the sensor 330, and the input/output unit 370. The memory 390 may store control programs for controlling the electronic device 300 and the controller 310, applications initially provided from a manufacturer or downloaded from outside, objects (e.g., images, texts, icons, buttons, etc.) for providing a graphical user interface (GUI) associated with the application, user information, documents, databases, or related data.

The memory 390 may include a broadcast receiving module, a channel control module, a volume control module, a communication control module, a voice recognition module, a motion recognition module, a light receiving module, a display control module, an audio control module, an external input control module, a power control module, a module for controlling power of a wirelessly connected external device (e.g., connected via Bluetooth communication), a voice database (DB), or a motion database. The modules (not shown) and the DBs (not shown) of the memory 390 may be embodied in the form of software for controlling the electronic device 300 to perform a broadcast reception control function, a channel control function, a volume control function, a communication control function, a voice recognition function, a motion recognition function, a light reception control function, a display control function, an audio control function, an external input control function, a power control function or a function for controlling power of a wirelessly connected external device (e.g., connected via a Bluetooth communication). The controller 310 may perform the above-stated functions by using the software stored in the memory 390.

The electronic devices 200 and 300 of FIGS. 2 and 3 are merely examples. The components illustrated in FIGS. 2 and 3 may be integrated, added, or omitted according to the description of the actually implemented image display apparatus 100. In other words, as occasion demands, two or more components may be combined into one component or one component may be divided into two or more components. Furthermore, the functions performed by the respective blocks are merely for describing the embodiments, and the present disclosure is not limited by particular operations or particular apparatuses.

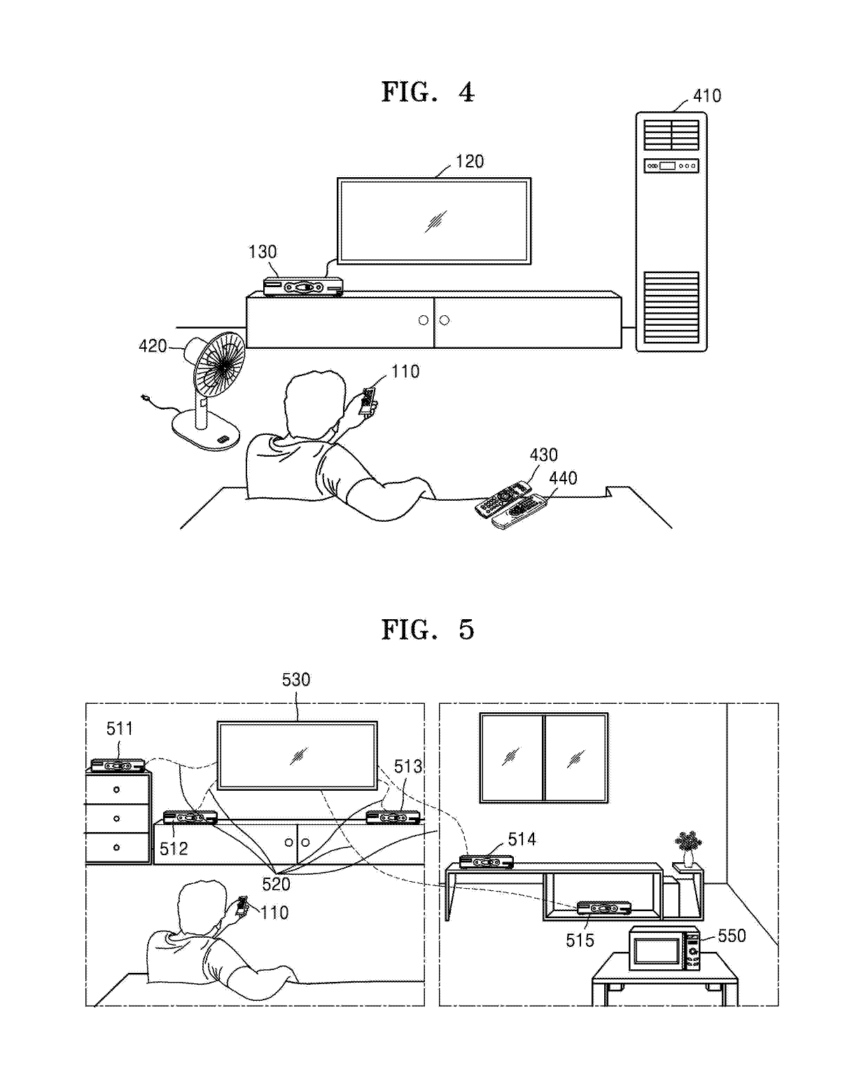

FIG. 4 is a diagram illustrating an example of controlling a plurality of peripheral devices 410 and 420 via the external electronic device 120 and the electronic device 130, according to an example embodiment.

According to an example embodiment, a user may control a peripheral device using a remote controller corresponding to the peripheral device.

For example, referring to FIG. 4, a peripheral device to be controlled by a user may include an air conditioner 410 or a fan 420. Furthermore, the user may control the air conditioner 410 using a first remote controller 430 and control the fan 420 using a second remote controller 440.

The user may control the peripheral device by directing a remote controller toward the electronic device 200 instead of directing the remote controller toward a corresponding peripheral device.

According to an embodiment, the electronic device 130 may receive an IR signal from a remote controller and generate a baseband signal by separating a carrier frequency from the received IR signal. The electronic device 130 may determine a carrier frequency corresponding to the baseband signal based on remote control code information included in the baseband signal. The electronic device 130 may combine the determined carrier frequency with the baseband signal and transmit the same to a peripheral device. Since a detailed description thereof has been given above with reference to FIGS. 1A, 1B, and 2, a detailed description thereof will be omitted below.

FIG. 5 is a diagram illustrating an example of controlling a peripheral device 550 via electronic devices 511, 512, 513, 514, and 515, according to an example embodiment.

According to an example embodiment, one external electronic device 530 may be connected (520) to a plurality of electronic devices 511, 512, 513, 514, 515. More particularly, the one external electronic device 530 may transmit baseband signals to communicators of the plurality of electronic devices 511, 512, 513, 514, and 515. The connection 520 between the one external electronic device 530 and the plurality of electronic devices 511, 512, 513, 514, 515 may be a wired connection or a wireless connection.

It will be apparent to one of ordinary skill in the art that a method of combining external electronic device 120 with electronic device 130 is not limited to the combination of one external electronic device 530 and a plurality of electronic devices 511, 512, 513, 514, 515, and a plurality of external electronic devices may also be combined with one electronic device or a plurality of external electronic devices may also be combined with a plurality of electronic devices.

As illustrated in FIG. 5, according to an embodiment, the external electronic device 530 transmits a baseband signal to communicators of the electronic device 514 and 515 located in a space different from that of the external electronic device 530. The electronic devices 514 and 515 may transmit signals for controlling the peripheral device 550 to the peripheral device 550 located in the same space as the electronic devices 514 and 515.

According to the embodiment illustrated in FIG. 5, a user may control the peripheral device 550 located in a space different from that of the external device 530 by simply directing the remote controller device 110 toward the external electronic device 530 and transmitting an IR signal.

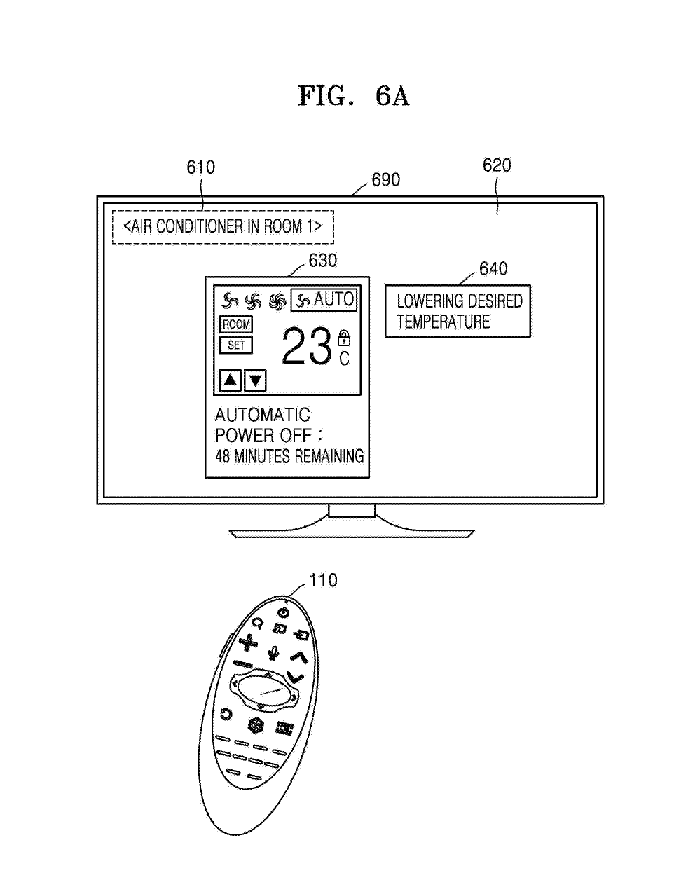

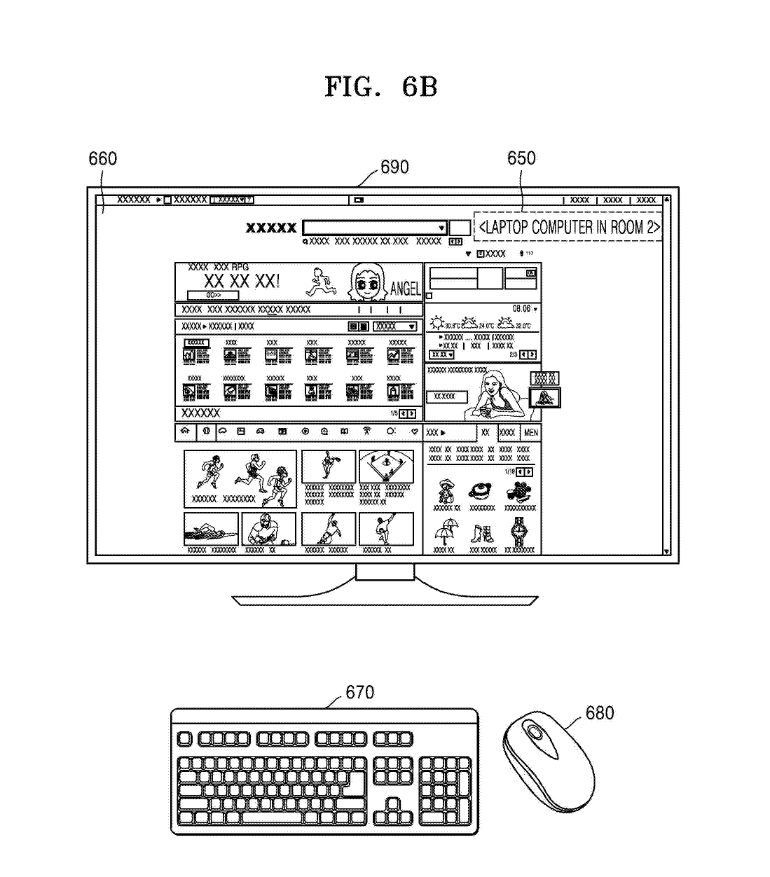

FIGS. 6A and 6B are diagrams illustrating examples of a screen image displayed on a display 620 of an electronic device when a peripheral device is being controlled by using the remote controller device 110, according to an example embodiment.

An electronic device 690 of FIGS. 6A and 6B is an example of the electronic device 200 of FIG. 2.

Referring to FIG. 6A, the electronic device 690 according to an embodiment may display information including a type of peripheral device controlled by a remote controller and a location of the peripheral device, on the display 620. For example, the electronic device 690 may display a text ‘Air Conditioner in Room 1” 610.

FIG. 6A is a diagram illustrating an example of a screen image displayed on an electronic device when a peripheral device is being controlled by using the remote controller device 110, according to an embodiment. Information including type of a peripheral device being controlled by the remote controller 110 and location of the peripheral device may be displayed on the display 620 of the electronic device of FIG. 6A. For example, the text “Air Conditioner in Room 1” 610 may be displayed.

Furthermore, as illustrated in FIG. 6A, a menu screen image 630 for controlling a peripheral device may be displayed on the display 620 of the electronic device. For example, a menu screen image for setting a current temperature, a desired temperature, a current wind speed, and an air cleaning mode may be displayed. In another example, when a timer that automatically turns OFF power is set, a remaining time until automatic power OFF may be displayed.

Furthermore, according to an embodiment, a current control command may be displayed on the display 620 of the electronic device. For example, as illustrated in FIG. 6A, when a user transmits a signal for lowering the desired temperature of the air conditioner, a text “lowering desired temperature” 640 may be displayed on the display 620 of the electronic device.

FIG. 6B is a diagram illustrating an example of a screen image displayed on the electronic device 690 while a peripheral device is being controlled using the remote controller device 110, according to an example embodiment.

Referring to FIG. 6B, the remote controller device 110 according to an embodiment may include a keyboard 670 or a mouse 680. More particularly, the keyboard 670 may be implemented as an infrared keyboard, and the mouse 680 may be implemented as an infrared mouse. However, the present disclosure is not limited thereto.

For example, the electronic device 690 may receive a control signal as a user manipulates a keyboard or mouse, and the electronic device 690 may transmit a control signal to a laptop computer 650, which is a peripheral device located in a Room 2. In other words, the user may control the laptop computer 650 in the Room 2 by manipulating the keyboard or the mouse.

Information including type of a peripheral device being controlled by the remote controller 110 and location of the peripheral device may be displayed on a display 660 of the electronic device 690 of FIG. 6B. For example, a text “Laptop Computer in Room 2” 650 may be displayed.

The display 660 of the electronic device 690 may display a screen image identical to the screen image displayed on the peripheral device. For example, as illustrated in FIG. 6B, a screen image identical to the screen image displayed on the laptop computer in the Room 2 may be displayed on the display 660 of the electronic device 690.

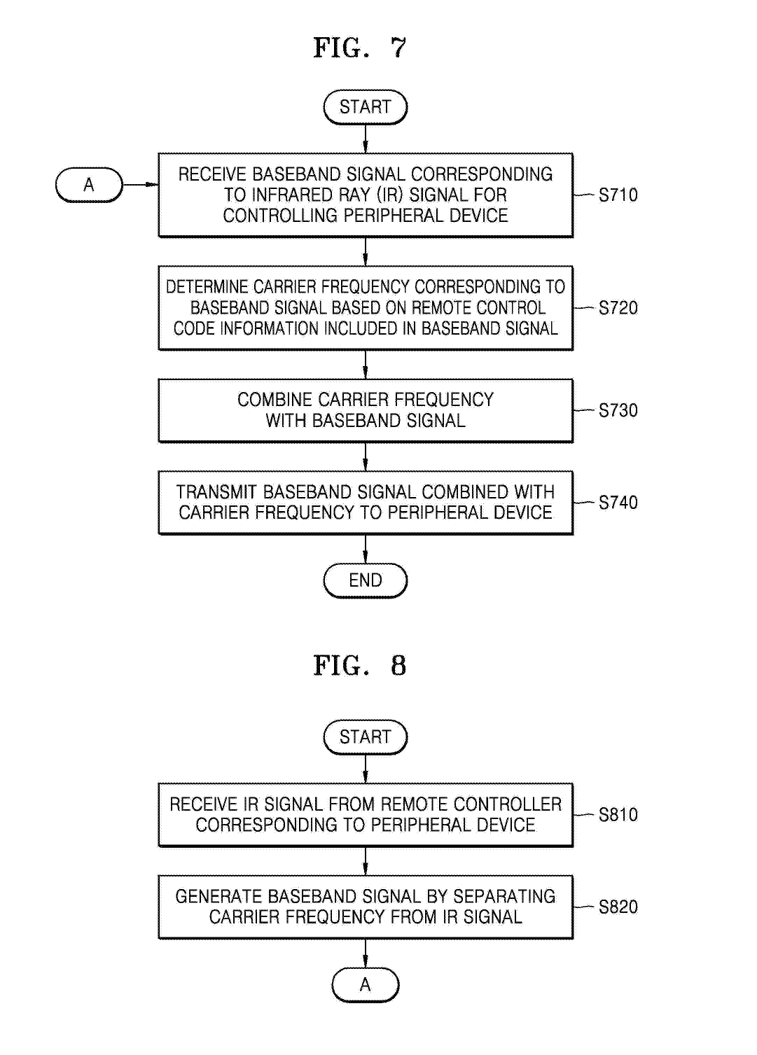

FIG. 7 is a flowchart illustrating an example method of operating the electronic device 200, according to an example embodiment.

Referring to FIG. 7, in operation S710, the electronic device 200 may receive a baseband signal corresponding to an IR signal for controlling a peripheral device.

The baseband signal received in the operation S710 may be a baseband signal obtained by separating a carrier frequency from an IR signal received from the remote controller device 110.

In operation S720, the electronic device 200 may determine a carrier frequency corresponding to the baseband signal based on remote control code information included in the baseband signal.

According to an embodiment, the electronic device 200 may store a database containing information regarding carrier frequencies corresponding to remote control code information.

According to an embodiment, remote control code information may include, but is not limited to, a lead code, a custom code, and a data code. Furthermore, the respective remote control apparatuses 110 may have different lead codes, different custom codes, and different data codes.

According to an embodiment, the electronic device 200 may determine a carrier frequency by comparing the database stored in the electronic device 200 with the remote control code information included in the baseband signal.

According to an embodiment, the electronic device 200 may generate a particular frequency. More particularly, the electronic device 200 may generate a frequency within a certain error range around the carrier frequency. In other words, the electronic device 200 may generate a frequency within a certain frequency range around the carrier frequency.

In operation SS730, the electronic device 200 may combine the carrier frequency with the baseband signal.

According to an embodiment, the electronic device 200 may combine a frequency within a pre-set error range around the carrier frequency with the baseband signal.

In operation SS740, the electronic device 200 may transmit the baseband signal combined with the carrier frequency to a peripheral device.

According to an embodiment, the electronic device 200 may transmit an IR signal generated by combining a frequency within a pre-set error range around the carrier frequency with the baseband signal to a peripheral device.

FIG. 8 is a flowchart illustrating an example method of operating the electronic device 200, according to an example embodiment.

In operation S810, the electronic device 200 may receive an IR signal from a remote controller corresponding to a peripheral device.

According to an embodiment, the IR signal received from the remote controller corresponding to the peripheral device may include a control signal. More particularly, the IR signal received from the remote controller corresponding to the peripheral device may include a baseband signal.

In operation S820, the electronic device 200 may generate a baseband signal by separating a carrier frequency from the IR signal.

According to an embodiment, the electronic device 200 may generate a baseband signal by separating a frequency within a pre-set error range around the carrier frequency from the IR signal.

The electronic device 200 according to an embodiment may perform operations S710 through S740 of FIG. 7 after the operation S820, and, in operation S710, the subject that receives a baseband signal may be the controller 230 of the electronic device 200.

According to an embodiment, a difference between magnitude of a carrier frequency combined with a baseband signal in the operation S730 and magnitude of the carrier frequency separated from the IR signal in the operation S820 may be within a pre-set error range.

According to an embodiment, the electronic device 200 corresponding to the external electronic device 120 may transmit the baseband signal to the electronic device 200 corresponding to the electronic device 130. In other words, the electronic device 200 corresponding to the electronic device 130 may receive the baseband signal from the electronic device 200 corresponding to the external electronic device 120.

According to an embodiment, a process of performing the method shown in FIGS. 7 and 8 may be displayed on a display screen of the electronic device 200.

Furthermore, the electronic device 200 may display information for controlling a peripheral device on the display screen. Since a detailed description thereof has been given above with reference to FIGS. 6A and 6B, a detailed description thereof will be omitted below.

It is to be understood that the foregoing description is for the purpose of illustration and that those skilled in the art will readily understand that various changes in form and details may be made therein without departing from the spirit and scope of the present disclosure. It is therefore to be understood that the various example embodiments described above are illustrative in all aspects and not restrictive. For example, each component described as a single entity may be distributed and implemented, and components described as being distributed may also be implemented in a combined form.

It should be understood that the various embodiments described herein should be considered in a descriptive sense only and not for purposes of limitation. Descriptions of features or aspects within each embodiment should typically be considered as available for other similar features or aspects in other embodiments.

While one or more example embodiments have been described with reference to the figures, it will be understood by those of ordinary skill in the art that various changes in form and details may be made therein without departing from the spirit and scope as defined by the following claims.

What is claimed is:

1. An electronic device comprising:
a controller configured to receive a baseband signal corresponding to an infrared ray (IR) signal for controlling a peripheral device, to determine a first carrier frequency corresponding to the baseband signal based on remote controller code information included in the baseband signal, and to combine the first carrier frequency with the baseband signal; and
a transmitter configured to transmit the baseband signal combined with the first carrier frequency to the peripheral device.

2. The electronic device of claim 1, further comprising a receiver configured to receive the IR signal from a remote controller corresponding to the peripheral device and to generate the baseband signal by separating a second carrier frequency from the IR signal.

3. The electronic device of claim 2, wherein a difference between a magnitude of the first carrier frequency and a magnitude of the second carrier frequency is within a predetermined error range.

4. The electronic device of claim 1, further comprising a display configured to display information for controlling the peripheral device corresponding to the baseband signal.

5. The electronic device of claim 1, further comprising a communicator comprising communication circuitry configured to receive the baseband signal from an external electronic device.

6. The electronic device of claim 1, further comprising a memory configured to store information regarding first carrier frequencies corresponding to remote controller code information, wherein the controller is further configured to determine the first carrier frequency by comparing database information with the remote controller code information.

7. The electronic device of claim 1, wherein the remote controller code information comprises one or more of a lead code, a custom code, and a data code of the baseband signal.

8. The electronic device of claim 1, wherein the controller is further configured to generate the determined first carrier frequency.

9. A method of controlling an electronic device, the method comprising:
receiving a baseband signal corresponding to an infrared ray (IR) signal for controlling a peripheral device;
determining a first carrier frequency corresponding to the baseband signal based on remote controller code information included in the baseband signal;
combining the first carrier frequency with the baseband signal; and
transmitting the baseband signal combined with the first carrier frequency to the peripheral device.

10. The method of claim 9, further comprising:
receiving the IR signal from a remote controller corresponding to the peripheral device; and
generating the baseband signal by separating a second carrier frequency from the IR signal.

11. The method of claim 10, wherein a difference between a magnitude of the first carrier frequency and a magnitude of the second carrier frequency is within a predetermined error range.

12. The method of claim 9, further comprising displaying information for controlling the peripheral device corresponding to the baseband signal.

13. The method of claim 9, wherein the receiving of the baseband signal comprises receiving the baseband signal from an external electronic device.

14. The method of claim 9, wherein the determining of the first carrier frequency corresponding to the baseband signal comprises:
determining the first carrier frequency by comparing database information regarding first carrier frequencies corresponding to remote controller code information with the remote controller code information.

15. The method of claim 9, wherein the remote controller code information comprises one or more of a lead code, a custom code, and a data code of the baseband signal.

16. The method of claim 9, further comprising generating the determined first carrier frequency.

17. A non-transitory computer readable recording medium having recorded thereon a computer program for implementing the method of claim 9.
